(19) United States
(12) Patent Application Publication
(10) Pub. No.: US 2022/0343656 A1
(43) Pub. Date: Oct. 27, 2022

(54) Method and system for automated calibration of sensors

(71) Applicant: AVL Software and Functions GmbH, Regensburg (DE)

(72) Inventors: Arya Senna Abdul RACHMAN, Regensburg (DE); Ying LIU, Regensburg (DE)

(21) Appl. No.: 17/723,719

(22) Filed: Apr. 19, 2022

(30) Foreign Application Priority Data
Apr. 22, 2021 (DE) 102021110287.1

(51) Int. Cl. G06V 20/56; G06V 10/46; G01S 17/894

(52) U.S. Cl. CPC G06V 20/56; G06V 10/476; G06V 10/473; G01S 17/894; G01S 7/497

(57) ABSTRACT

The invention relates to a method for automated calibration of sensors of a vehicle, wherein at least one first passive optical sensor and at least one second active optical sensor are calibrated by a calibration unit based on a matching spatial orientation of recognised environmental features in transformed sensor data of the first sensor and the sensor data captured by the second sensor.

The invention relates to a method for automated calibration of sensors, a system for carrying out such a method and a vehicle equipped with the system.

The number of sensors for capturing a wide variety of measured variables has increased significantly in various fields of application in recent years. In this way, physical and chemical properties of the environment can be captured qualitatively and quantitatively using the measured variable in the form of sensor data. Joint arrangements of several, in particular different, sensors are also playing an increasingly important role. This applies in particular to automated processes and their systems, in which various measured variables have to be related to one another.

One such example is vehicles in general, and especially those which are designed for autonomous driving. Nowadays in a modern car there are a large number of different sensors which, on the one hand, assist the driver and, on the other hand, ensure the safety of the driver and other road users. These sensors are usually combined in the so-called driver assistance system (“Advanced Driver Assistance Systems”; abbreviated to ADAS). It is crucial here that the sensors are correctly matched to one another, i.e. calibrated, in order to be able to ensure the functionality of the systems mentioned.

It is known from the prior art that optical sensors (e.g. cameras), which represent a majority of the sensors arranged on the vehicle, are calibrated jointly at the factory. The vehicle is arranged in a stationary position in a specially designed calibration stand and the individual cameras are each calibrated to compensate for lens errors and to determine the position and orientation of the camera coordinate system (local coordinate system) in a higher-level world coordinate system. In addition, the relative orientation of the cameras with respect to one another is calibrated by a relative spatial translation and rotation of the camera coordinate systems or camera images, wherein known methods are used for this purpose. For the calibration, stationary and easily recognisable patterns, such as a chequerboard pattern, surrounding the vehicle are usually used.

Several disadvantages result from the calibration method described above. A specially designed calibration stand is required for the calibration, and must be set up appropriately and must offer sufficient space. The calibration has to be carried out laboriously, so to speak manually, by a technician specially trained for this purpose, wherein the calibration in particular comprises a large number of steps which have to be manually carried out consecutively in order to obtain a sufficient calibration quality. Furthermore, a calibration of the sensors must be carried out again whenever there is a change in the system, for example by replacement of a component. Such a calibration is complex and therefore costly and time-consuming and difficult for workshops to implement after delivery from the factory, since appropriately trained and educated personnel and an appropriate calibration stand are required in order to be able to carry out a necessary repeated calibration.

It is therefore the object of the present invention to provide a method and a system which overcome the stated disadvantages of the prior art.

This object is achieved by a method for automated calibration of sensors in a vehicle, comprising the steps of:
a. capturing sensor data relating to a vehicle environment passed through by the vehicle during operation by at least one first passive optical sensor arranged on the vehicle and at least one second active optical sensor arranged on the vehicle;
b. calibrating the at least one first sensor by determining intrinsic sensor parameters and distortion parameters based on the sensor data captured by the first sensor by a calibration unit and applying the intrinsic sensor parameters and the distortion parameters to the sensor data captured by the first sensor to obtain transformed sensor data;
c. recognising environmental features of the vehicle environment previously passed through in the transformed sensor data of the first sensor and the sensor data captured by the second sensor by a recognition unit; and
d. calibrating the at least one first sensor and the at least one second sensor based on a matching spatial orientation of the recognised environmental features in the transformed sensor data of the first sensor and the sensor data captured by the second sensor by the calibration unit, while determining extrinsic sensor parameters and applying the extrinsic sensor parameters to transformed sensor data from the first sensor and sensor data captured by the second sensor to obtain calibrated sensor data, respectively.

A vehicle within the meaning of the invention can in particular be any motor vehicle which is preferably driven by an internal combustion engine, an electric motor and/or a fuel cell. Furthermore, vehicles are also understood to mean, in particular, those vehicles which are provided and designed to drive autonomously.

According to the invention, the method is carried out while the vehicle is in operation. Operation is understood to mean that the vehicle is in motion or travelling, wherein the engine of the vehicle is active and propelling the vehicle. The vehicle is in a normal operating mode, so to speak, in which the vehicle is being driven by a driver. As a result, the position of the vehicle changes constantly during operation according to traffic, the roads, etc.

A vehicle environment through which the vehicle passes during operation is understood to mean the environment located around the vehicle which the vehicle drives past or is moved past. This can preferably involve any objects, such as buildings, vegetation, infrastructure, etc. It is preferably assumed that the sensors according to the invention are provided and designed to be able to capture the vehicle environment and to output sensor data relating to the vehicle environment.

It remains to be noted that, according to the invention, it is assumed that the vehicle is in motion or is driving when the method is being carried out. The method according to the invention is explicitly not to be carried out in a stationary calibration stand specially provided for this purpose. Furthermore, the vehicle environment should not be an environment in a calibration stand that is specifically provided for sensor calibrations and is accordingly deliberately arranged. Furthermore, automated calibration is understood to mean that the calibration is automated during operation of the vehicle, i.e. is carried out in a self-controlled manner, and no specially trained personnel are required in order to carry out the method or the individual steps. The sequence of the calibration method and its quality or success is preferably presented or indicated to a user or driver of the vehicle in such a way that he can understand it without having to have special knowledge. Automatic calibration also means that the calibration can preferably be started, stopped, restarted, etc., by the user.

A first sensor within the meaning of the invention is a passive sensor and the second sensor is an active sensor. An existing sensor provides sensor data. A sensor on the vehicle or a sensor of a vehicle is preferably a sensor which is arranged in or on the vehicle. Such a sensor can be part of the vehicle or can be integrated in and/or on the vehicle, for example as part of a driver assistance system, or it can be fitted subsequently in and/or on the vehicle. It is assumed that the first and second sensors are different sensors, i.e. the first and second sensors capture different measured variables.

The sensor data are preferably captured continuously by means of the corresponding sensors according to step a. during operation of the vehicle, i.e. new sensor data are always captured, and/or at specific time intervals and/or when specific events occur. An event can be, for example, an activation by an occupant of the vehicle.

According to the invention, the at least one first sensor is calibrated in order firstly to map the captured sensor data to the real world (preferably transformation of the two-dimensional sensor data into the three-dimensionally captured environment) and also to compensate for any errors which occur when the sensor data are captured by the sensors and represent differences between the vehicle environment in the sensor data and the real vehicle environment (e.g. distortions or the like). As a result of the calibration, the sensor data of the at least one first sensor can be used in the form of the transformed sensor data for the further method. The calibration takes place by determining intrinsic sensor parameters and distortion parameters based on the sensor data captured by the first sensor, preferably based on a mathematical model or by means of an algorithm. The intrinsic sensor parameters indicate, among other things, the position of the sensor relative to the sensor data (related to an image measured variable of the optical sensor) and the position and orientation of the sensor coordinate system in a higher-level world coordinate system (the vehicle environment) or position of the sensor relative to the captured sensor data (in other words, a recorded object in the sensor data).

The distortion parameters are determined based on a known sensor model (e.g. a lens model), corresponding to the first sensor which captures the sensor data, and are used to correct imaging errors (distortion) which result from the structure of the sensor itself (including from the lens equation) and environmental influences such as temperature, weather, or the like. Furthermore, the distortion parameters are used to correct errors due to mechanical influences, which can be caused, for example, by vibrations caused by the movement of the vehicle during operation, and also affect the sensors. In the context of the invention, according to which the automated calibration of the sensors is carried out while the vehicle is in operation, i.e. the vehicle is in motion, the correction of mechanical influences by the distortion parameters is particularly relevant and in this way makes the method significantly more robust under the given conditions and more able to be carried out successfully than known methods.

By application of the intrinsic sensor parameters and the distortion parameters to the sensor data captured by the first sensor, transformed sensor data are obtained which are transformed or corrected in such a way that they realistically reproduce the vehicle environment and are suitable for further use in the method. One could say that the transformed sensor data are two-dimensionally captured sensor data which have been converted or transformed back into three-dimensional reality (or the world coordinate system). For the calibration of the first sensor, a spatial orientation and movement of the vehicle is preferably included which can be estimated (preferably by means of known odometry) and/or captured as a measured variable (preferably GNSS data or also GPS data with RTK (Real-Time Kinematic)).

The calibration of the first sensor is preferably carried out based on sensor data which have been captured from different viewing angles. It is particularly advantageous here that the vehicle passes through the vehicle environment, i.e. drives past the vehicle environment, and sensor data which are consecutive in time are thus automatically captured from different viewing angles. The calibration of the first sensor is particularly preferably based on mathematical (camera) models or algorithms, such as the (extended) pinhole camera model, the fisheye model, resection and/or bundle adjustment, wherein the models or algorithms do not have to be limited to these examples. Preferably, in particular in the course of the calibration by means of bundle adjustment, environmental features of the vehicle environment previously passed through can be recognised, wherein sensor data from different viewing angles are advantageously included and wherein the spatial orientation and movement of the vehicle is estimated for this purpose and/or measured data are used. A method analogous to step d. is preferably used for the recognition of environmental features which are shown below, or another method.

As an example, reference is made here to the calibration of cameras, which takes place in a known manner by determining the inner and outer orientation (intrinsic sensor parameters).

These camera calibrations and the way they work are sufficiently known from the prior art and should be regarded as disclosed in the context of the invention.

Environmental features are understood to be objects in the vehicle environment which have been captured by the sensors. The environmental features are, for example, buildings, vegetation or the like which are arranged in the vehicle environment.

A calibration of the at least one first sensor and the at least one second sensor, based on a matching spatial orientation of the recognised environmental features in the transformed sensor data of the first sensor and the sensor data captured by the second sensor by the calibration unit with determination of extrinsic sensor parameters, is understood as a relative spatial translation and/or rotation of the transformed sensor data of the first sensor with respect to the sensor data of the second sensor or of the respective known sensor coordinate systems. The extrinsic sensor parameter comprises a specific rotation matrix and/or a specific translation matrix, which reflects the rotation and/or translation of the sensor data. The rotational and/or translational operations are carried out in such a way that the environmental features recognised in the transformed sensor data of the first sensor and the sensor data of the second sensor are arranged congruently or oriented spatially in the same way (also called “homogeneous transformation”). Consequently, the difference in the spatial orientation of the recognised environmental features is minimised, which is preferably achieved by the minimisation of a corresponding mathematical function by the calibration unit. In this way, the relative orientation or alignment of the at least one first sensor and the at least one second sensor can be determined. Calibrated sensor data are obtained by application of the extrinsic sensor parameter to the sensor data of the first and second sensors, wherein the calibrated sensor data are related to a coordinate system common to the at least one first sensor and the at least one second sensor, wherein objects, items and/or persons are in the same positions in the sensor data for all sensors. The calibration unit is provided and designed to carry out the calibration of the first and second sensors according to the invention based on a minimisation of the mathematical function which specifies the deviation in the spatial orientation of the environmental features. The sensor data of the sensors calibrated according to the invention are then used for all further evaluations or by all further systems on the vehicle.

The method according to the invention ensures that different optical sensors, which are arranged at different positions in and/or on the vehicle, can be calibrated to a common sensor coordinate system by spatially matching orientation of environmental features in the captured sensor data which relate to the vehicle environment passed through. Due to the fact that the sensors are arranged in a stationary manner in and/or on the vehicle, the differences in the spatial orientation of the recognised environmental features result solely from the different positioning of the sensors in and/or on the vehicle. Environmental features in the vehicle environment through which the vehicle passes or which the vehicle drives past are advantageously used for the calibration, wherein a special calibration stand or the like can be dispensed with and the calibration can take place during normal operation of the vehicle. Such calibration is particularly relevant for sensors of the driver assistance system if pedestrians and/or cyclists are to be clearly recognised.

According to a preferred embodiment, in step a. the sensor data are captured by the first sensor and the second sensor at the same time. The calibration of the first and second sensors in step d. is preferably carried out based on sensor data captured at the same time. In this way, the different spatial orientations of the environmental features in the sensor data of the first and second sensors result solely from the different positioning of the sensors in and/or on the vehicle.

According to a preferred embodiment, the environmental features are at least parts of substantially static objects which are arranged in the vehicle environment passed through by the vehicle during operation and were detected by the at least one first sensor and the at least one second sensor using the sensor data. The static objects in the vehicle environment are preferably objects which are arranged in a stationary manner, i.e. their spatial orientation or position in the vehicle environment does not change substantially. Therefore it can preferably be assumed that a different spatial orientation of the environmental features results solely from the different positioning of the sensors. Such static objects in the vehicle environment are preferably buildings, vegetation or the like. The static objects are not recognised as such, but parts or portions of the static objects are recognised, which are identified, for example, by clearly defined corners and/or edges of buildings or high-contrast colour differences. It should be made clear that the static objects are not objects intended specifically for the calibration, such as chequerboard patterns, circular marks or barcodes which were arranged in the vehicle environment specifically for the purpose of sensor calibration. The environmental features are preferably recognised by the recognition unit by means of a gradient-based or a keypoint-based method. The environmental features in the sensor data are preferably recognised using colour, contrast and/or intensity gradients in the case of gradient-based recognition (“gradient orientation measure”). The environmental features are preferably recognised in a keypoint-based recognition based on the SIFT method (“Scale Invariant Feature Transform”). The functioning and application of gradient-based and also keypoint-based methods are sufficiently known from the prior art. It would also be conceivable for other suitable methods to be used instead of or in addition to gradient-based or keypoint-based methods.

According to a preferred embodiment, the at least one first sensor is designed as a monocular camera or as a stereo camera. The at least one second sensor preferably uses radar, lidar or ultrasound technology or is designed as a time-of-flight camera. A plurality of first and second sensors can be provided, wherein each first sensor is calibrated with each second sensor in accordance with the method according to the invention. The first sensor therefore preferably supplies sensor data in the form of 2D images and the second sensor supplies sensor data in the form of a point cloud or a point cluster or a depth map. These sensor types are used in particular for driver assistance systems and are also of great importance in connection with autonomous driving, which is why their calibration is of great relevance. It is conceivable that other sensor types which are not explicitly mentioned here can also be used for the method.

Any number of first and second sensors are preferably provided, wherein each first sensor is calibrated with each second sensor according to the method shown.

According to a preferred embodiment, steps a. to c. are continuously repeated. In step c., recognised environmental features, if they are recognised as matching in a plurality of sensor data captured consecutively in terms of time and/or location, are preferably stored by the recognition unit as consistent environmental features or are otherwise deleted. Step d. is preferably carried out only when the number of consistent environmental features exceeds a predetermined first threshold value. The number of consistent environmental features is preferably compared by the evaluation unit with the threshold value to determine whether that value is exceeded. In this way, the calibration of the sensors is only performed on the basis of the consistent environmental features which have been recognised as matching in a plurality of consecutively captured sensor data. The number of consecutively captured sensor data, which constitutes a consistent environmental feature, can preferably be defined as desired. The environmental features which are assessed as inconsistent are deleted as untrustworthy and not used for further calibration. Sensor data captured consecutively in terms of time are preferably understood to be sensor data which are captured consecutively, such as when driving past the vehicle environment. Sensor data captured consecutively in terms of location are preferably understood to be sensor data which have been captured at the same location or from the same vehicle position, wherein it is assumed here that in the case of sensor data captured consecutively in terms of location the sensors pass through the same vehicle environment and thus substantially the same environmental features can be recognised. A matching recognition is preferably understood to mean that the environmental features in the sensor data match in terms of space or location, wherein it can be assumed that the environmental features are at least part of a substantially static object, the spatial orientation of which does not change in relation to the sensor data. This enables advantageous calibration of the sensor data, since the differences in the spatial orientation of the environmental features substantially only result from the different sensor positions. The predeterminable first threshold value is an arbitrarily determinable value or number of consistent environmental features, wherein the higher the threshold value the more reliable the calibration is, but many consistent environmental features must be recognised.

According to a preferred embodiment, a distribution parameter is determined by an evaluation unit, which indicates a spatial distribution of the consistent environmental features in the respective sensor data. Step d. is preferably carried out only when the number of consistent environmental features exceeds the first threshold value and when the value of the distribution parameter exceeds a predetermined second threshold value. The distribution parameter preferably reflects how the consistent environmental features are spatially distributed on/in the sensor data, wherein the greater the spatial distribution, the larger the distribution parameter is. It would also be conceivable to designate the distribution parameter as a coverage parameter, in which case the distribution of the environmental features on/in the sensor data can also be referred to as a coverage of the sensor data with the environmental features. It is assumed that due to a greater distribution of the consistent environmental features on/in the sensor data, a plurality of static objects are involved and thus a more reliable calibration is possible, in contrast to the case when the recognised environmental features are restricted to a spatially limited area. This embodiment ensures that step d. is only carried out when a certain number of consistent environmental features have been recognised which are also sufficiently distributed.

According to a preferred embodiment, a third sensor is provided on the vehicle. The third sensor is preferably provided and designed to capture the spatial orientation and movement of the vehicle. The captured spatial orientation and movement of the vehicle are also preferably used for calibrating the at least one first sensor in step b. More preferably, the third sensor is a GNSS receiver. In the context of the calibration of the first sensor according to step b. the spatial orientation and movement of the vehicle is sometimes required, wherein this can be estimated using the sensor data (from different viewing angles). However, sensor data which precisely reflect the spatial orientation and movement of the vehicle are more suitable for this purpose and thus contribute to a more precise calibration.

According to a preferred embodiment, the calibration unit, the recognition unit and/or the evaluation unit are arranged on the vehicle or external to the vehicle. The calibration unit, the recognition unit and/or the evaluation unit can be designed particularly preferably as part of a common computing unit. The calibration unit, the recognition unit and/or the evaluation unit are preferably designed externally to the vehicle as part of a data processing system or are cloud-based. The intrinsic sensor parameters, the extrinsic sensor parameters, the distortion parameters, the consistent environmental features and/or the distribution parameter can preferably be stored in a retrievable manner on a memory unit arranged on the vehicle or external to the vehicle. The calibration unit, the recognition unit and/or the evaluation unit on the vehicle are preferably designed as part of the existing driver assistance system or are arranged subsequently in and/or on the vehicle.

A data processing system within the meaning of the invention is to be understood as an IT infrastructure which, in particular, comprises a memory, computing power and, if applicable, application software. A data processing system according to the invention is preferably set up and provided for receiving, sending, processing and/or storing data. According to this, an external data processing system is a data processing system which is arranged outside the vehicle.

According to a preferred embodiment, the calibration unit, the recognition unit and/or the evaluation unit or the data processing system and/or the cloud are designed to use an artificial intelligence (Al) and preferably a neural network for calibrating the sensors (steps b. and d.) and for recognising the environmental features (step c.). The terms “machine learning” and “deep learning”, which are relevant in connection with the application of artificial intelligence (Al) and neural networks, should be advantageously mentioned here.

According to a preferred embodiment, a sequence of the method is displayed on the display device based on the number of consistent environmental features relative to the first threshold value and the value of the distribution parameter relative to the second threshold value.

In this way, the sequence of the method can be followed by a user, possibly a vehicle occupant. More preferably, an operating device is provided, by means of which the sequence of the method can be regulated by a user. The display device can be a screen permanently installed in the vehicle (e.g. of the multimedia system and/or the vehicle navigation system), a smartphone, a tablet and/or a laptop, although the list is not to be understood as being exhaustive. In the case of an autonomous or remote-controlled vehicle, the display device is particularly preferably arranged outside the vehicle. The display device allows the user, e.g. a driver and/or a vehicle occupant, to follow the calibration process, wherein the sequence or progress is displayed relative to the corresponding threshold value based on the number of recognised or stored consistent environmental features and the value of the distribution parameter. Furthermore, the method can be regulated by means of the operating device (e.g. as part of a touchscreen), wherein the method can be started, stopped, interrupted or restarted.

According to a preferred embodiment, the sensor data and/or the various parameters are sent from the vehicle to the data processing system or the cloud and vice versa by means of a wireless connection, which is preferably based on a transmission technology selected from a group comprising WLAN connection and radio connection, mobile radio connection, 2G connection, 3G connection, GPRS connection, 4G connection, 5G connection includes. The wireless connection advantageously has a comparatively long range, at least in sections, preferably with a maximum range of over 100 m, preferably over 500 m, preferably over 1 km, particularly preferably several km. In this way, the data can be sent from the vehicle to the data processing system/cloud and vice versa, regardless of the respective geographic positions. The wireless connection or the transmission technology is preferably a bidirectionl connection.

The object is also achieved by a system for carrying out a method according to any of the preceding claims, comprising at least one first sensor and at least one second sensor, a calibration unit and a recognition unit.

The sensors are preferably connected to the calibration unit and the recognition unit, at least in signalling terms. More preferably, the sensors are also connected to an evaluation unit, at least in signalling terms. The calibration unit, the recognition unit and/or the evaluation unit are also preferably connected at least in signalling terms. The calibration unit, the recognition unit and/or the evaluation unit are particularly preferably designed as part of a computing unit. The calibration unit, the recognition unit and the evaluation unit or the computing unit are preferably connected to a data processing system external to the vehicle or cloud, at least in signalling terms.

The sensors are preferably provided and designed to capture the vehicle environment in terms of measured variables and to output sensor data relating to the vehicle environment and to transmit it to the appropriate units.

The calibration unit is preferably provided and designed to calibrate the at least one first sensor by determining the intrinsic sensor parameters and the distortion parameters based on the sensor data captured by the first sensor, wherein a mathematical model or an algorithm is preferably used for this purpose. Furthermore, the calibration unit is preferably provided and designed to apply the determined intrinsic sensor parameters and distortion parameters to the sensor data of the first sensor and thus to obtain transformed sensor data which can be used for the further method. Furthermore, the calibration unit is provided and designed to calibrate the at least one first sensor and the at least one second sensor based on a matching spatial orientation of the recognised environmental features in the transformed sensor data of the first sensor and the sensor data captured by the second sensor, while determining extrinsic sensor parameters, and to apply the extrinsic sensor parameters to transformed sensor data of the first sensor and sensor data acquired by the second sensor, to obtain calibrated sensor data in each case.

The recognition unit is preferably provided and designed to recognise environmental features of the vehicle environment previously passed through in the transformed sensor data of the first sensor and the sensor data captured by the second sensor. The recognition is preferably based on mathematical models or an algorithm, wherein these mathematical methods are known from the prior art. The recognition unit is also provided and designed to determine/recognise and to store consistent environmental features.

The evaluation unit is preferably provided and designed to determine a distribution parameter which specifies a spatial distribution of the consistent environmental features in the respective sensor data. Furthermore, the evaluation unit is provided and designed to compare the number of consistently stored environmental features with the first threshold value and to compare the value of the distribution parameter with the second threshold value to determine whether they are exceeded and to enable the step or to have it carried out if the value is exceeded.

The object is also achieved by a vehicle which is equipped with a system for carrying out the method according to the invention.

It is conceivable that the system has been subsequently arranged on and/or in the vehicle or is already integrated into the vehicle. Furthermore, it is conceivable that the calibration unit, the recognition unit and the evaluation unit or the computing unit are designed as part of already existing computing units or are separate computing units which have been provided subsequently.

The features described for the method are intended to apply mutatis mutandis to the system and the vehicle, and vice versa.

Additional aims, advantages and expediencies of the present invention can be found in the following description in conjunction with the drawings. In the drawings:

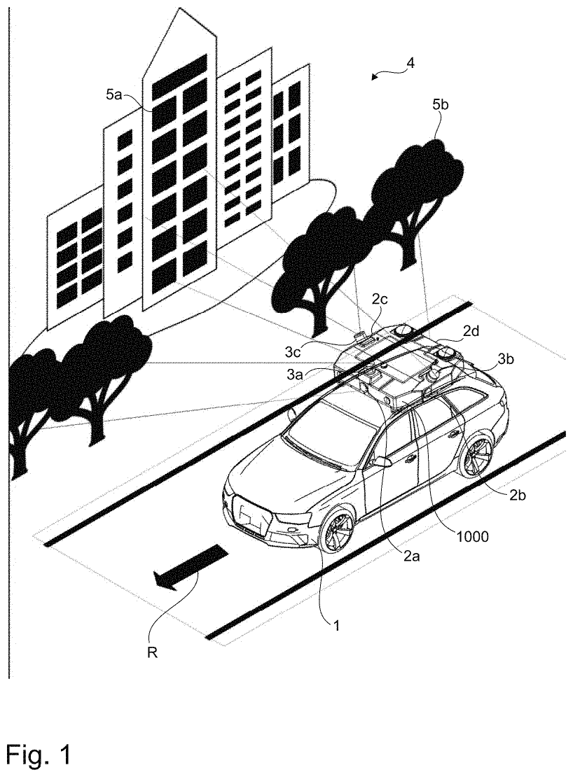

FIG. 1 shows a vehicle in a vehicle environment for calibrating sensors according to a preferred embodiment of the invention;

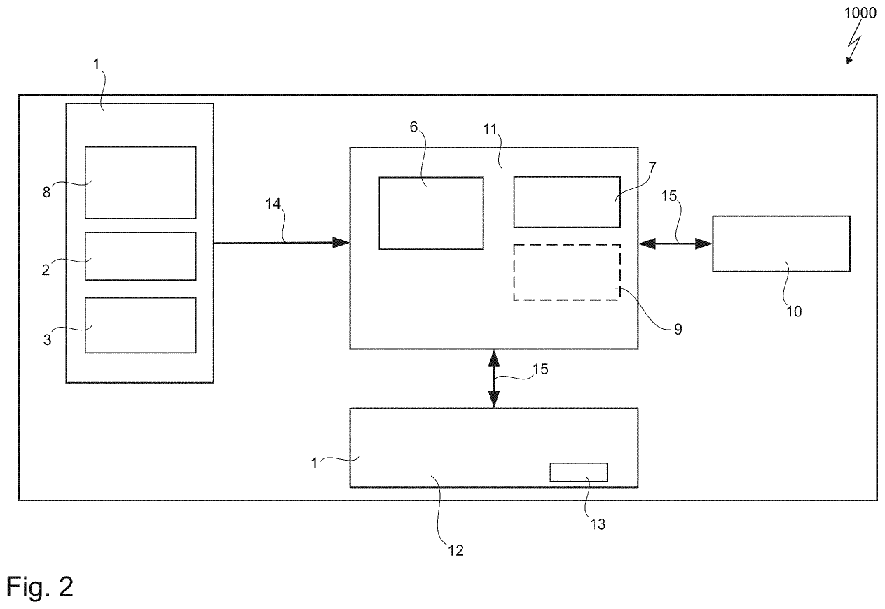

FIG. 2 is a schematic representation of a system for calibrating sensors according to a preferred embodiment;

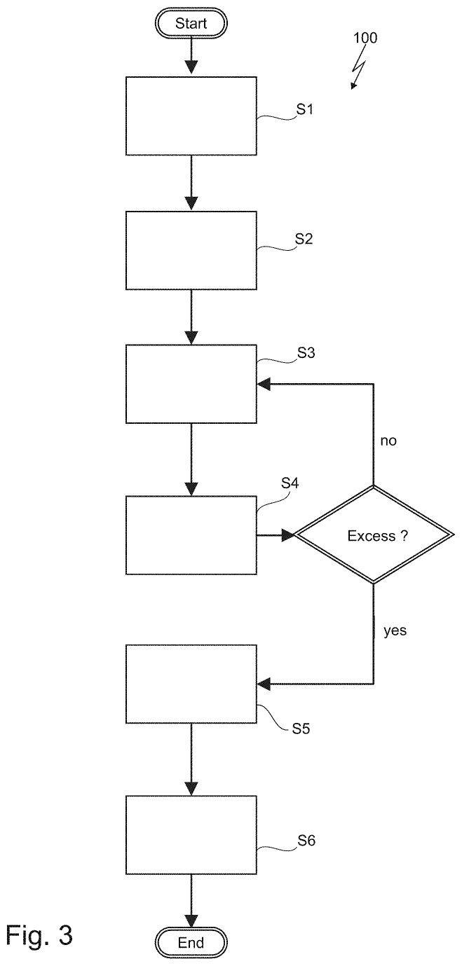

FIG. 3 shows a method for calibrating sensors using a flow chart according to a preferred embodiment;

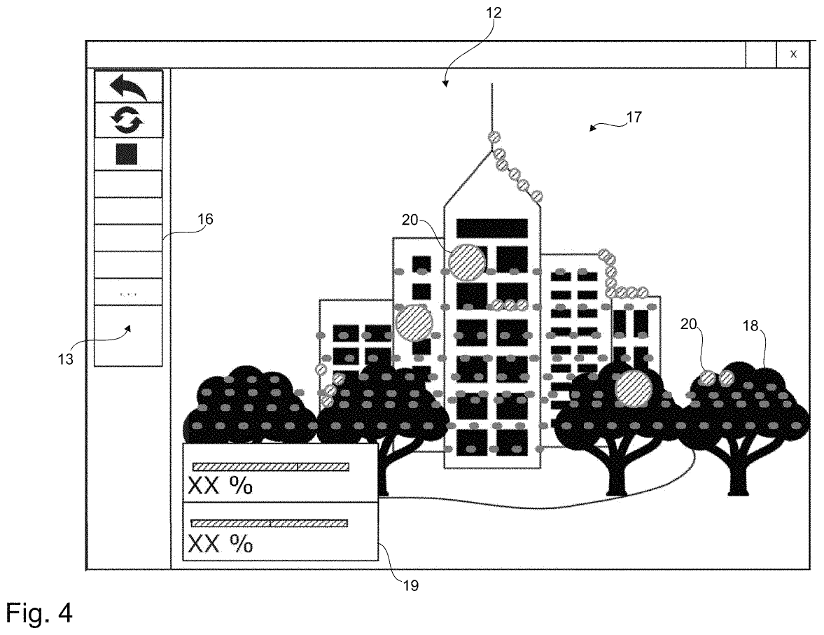

FIG. 4 shows a display device displaying the sequence of the method according to the invention according to a preferred embodiment.

FIG. 1 shows a vehicle 1 according to the invention which is equipped with a system 1000 according to the invention. The system 1000 includes sensors arranged on the vehicle which are to be calibrated. The vehicle 1 drives or moves in a movement direction R (indicated by an arrow) in a vehicle environment 4. By way of example, a plurality of buildings and trees are arranged in the vehicle environment.

The system 1000 is designed as a so-called roof box, which has been subsequently mounted on the vehicle roof. The system 1000 has four first passive optical sensors 2a, 2b, 2c, 2d, which are designed as cameras. The sensor 2a is oriented towards the front in the travel direction, the sensors 2c, 2c are oriented laterally perpendicular to the travel direction and the sensor 2d is oriented towards the rear contrary to the travel direction. In this way, the entire vehicle environment 4 around the vehicle 1 can be captured by the sensors 2a-d (cameras). The system 1000 also has three second active optical sensors 3a, 3b, 3c, which are designed as lidar sensors (distance sensors). The sensor 3a here is designed as a 360° lidar sensor with 32 layers and is oriented towards the front in the travel direction (capture area). The sensors 3b, 3c are designed as 360° lidar sensors with 16 layers and are oriented forwards in the travel direction (capture area). The sensor design and arrangement shown are only examples and can also be implemented differently.

The system 1000 according to FIG. 1 also comprises a calibration unit 6 and a recognition unit 7, which are not shown (see FIG. 2).

Two environmental features 5a, 5b, which can be recognised by the recognition unit 7 in the sensor data of the corresponding first sensors 2a-d and second sensors 3a-c, are shown as examples in the vehicle environment 4 through which the vehicle 1 passes while driving in the movement direction R. The environmental feature 5a is a part of a building, more precisely a window front or the transition from window to masonry. The environmental feature 5b relates to vegetation, more precisely a tree. The environmental features 5a, 5b are characterised in that they differ in colour and/or structure and are therefore easily recognisable.

A system 1000 according to a preferred embodiment is shown schematically in FIG. 2.

The system 1000 comprises at least one first sensor 2, at least one second sensor 3 and a third sensor 8, wherein the sensors 2, 3, 8 are arranged in and/or on the vehicle 1. The first sensor 2 is a passive optical sensor, such as a camera, the second sensor 3 is an active optical sensor, such as a lidar, radar or ultrasonic sensor, and the third sensor 8 is a position sensor, such as a GNSS receiver. The sensors 2, 3, 8 are each provided and designed to capture sensor data which comprise corresponding measured variables. The third sensor 8 is provided for this purpose and is designed to capture the spatial orientation and movement of the vehicle 1, wherein the sensor data of the third sensor 8 can also be used for calibrating the first sensor 2. The sensor data are transmitted to a computing unit 11 via at least one signalling connection 14, wherein the computing unit 11 comprises a calibration unit 6, a recognition unit 7 and an evaluation unit 9. The processing unit 11 can be arranged on the vehicle side and designed as part of the driver assistance system or independently (preferably as a general vehicle computing unit). Furthermore, the computing unit 11 could be designed as part of a data processing system or cloud which is arranged externally to the vehicle.

The calibration unit 6 is provided and designed to calibrate the at least one first sensor 2 by determining intrinsic sensor parameters and distortion parameters based on the sensor data captured by the first sensor 2, wherein a mathematical model or an algorithm is preferably used for this purpose in order to compensate for errors in the capture of the sensor data and to make the sensor data of the first sensor 2 usable for the further method. Furthermore, the calibration unit 6 is provided and designed to apply the determined intrinsic sensor parameters and distortion parameters to the sensor data of the first sensor 2 and thus to obtain transformed sensor data. Furthermore, the calibration unit 6 is provided and designed to calibrate the at least one first sensor 2 and the at least one second sensor 3 based on a matching spatial orientation of the recognised environmental features 5a, 5b in the transformed sensor data of the first sensor 2 and to calibrate the sensor data captured by the second sensor 3 by determining extrinsic sensor parameters and to apply the extrinsic sensor parameters to transformed sensor data of the first sensor 2 and sensor data captured by the second sensor 3 to obtain calibrated sensor data in each case.

The recognition unit 7 is provided and designed to detect environmental features 5a, 5b of the vehicle environment 4 previously passed through in the transformed sensor data of the first sensor 2 and the sensor data captured by the second sensor 3. The recognition preferably takes place based on mathematical models or an algorithm, which are preferably gradient-based or keypoint-based. The recognition unit 7 is also provided and designed to determine and to store consistent environmental features.

The evaluation unit 9 is preferably provided and designed to determine a distribution parameter which specifies a spatial distribution of the consistent environmental features 5 in the respective sensor data. Furthermore, the evaluation unit 9 is provided and designed to compare a number of consistent environmental features 5 and the value of the distribution parameter with an assigned predetermined threshold value in each case and to enable step d. only when the threshold values are exceeded.

The computing unit 11 is connected to a memory unit 10 via a bidirectional signalling connection 15. The intrinsic and extrinsic sensor parameters, the distortion parameter, the distribution parameter, the consistent environmental features and/or sensor data can be stored on the memory unit 10 in a retrievable manner.

Furthermore, the computing unit 11 is connected via a bidirectional signalling connection 15 to a display device 12 with an operating device 13, wherein the display device is arranged in the vehicle 1. The display device 12 is provided and designed to display a sequence of the method based on the number of consistent environmental features relative to the first threshold value and the value of the distribution parameter relative to the second threshold value, so that the sequence of the method can be followed by a user, such as a vehicle occupant. The sequence of the method can be regulated by a user via the operating device 13.

FIG. 3 shows a preferred embodiment of the method 100 according to the invention using a flow chart.

The method 100 can start automatically when the vehicle 1 is put into operation or started, or it can be started manually by a user using the operating device 13.

The method begins with a step S1 (corresponding to step a) and the capture of sensor data relating to a vehicle environment 4 passed through by the vehicle 1 during operation by at least one first passive optical sensor 2 arranged on the vehicle and at least one second active optical sensor 3 arranged on the vehicle.

The at least one first sensor 2 is then calibrated by a calibration unit 6 according to step S2 (corresponding to step b), determining intrinsic sensor parameters and distortion parameters based on the sensor data captured by the first sensor 2, and the intrinsic sensor parameters and the distortion parameters are applied to the sensor data captured by the first sensor 2, wherein transformed sensor data are obtained.

In a subsequent step S3 (corresponding to step c), environmental features 5 of the vehicle environment 4 previously passed through are recognised by a recognition unit 6 in the transformed sensor data of the first sensor 2 and the sensor data captured by the second sensor 3. Furthermore, environmental features 5 are stored as consistent environmental features 5 by the recognition unit 6 or are otherwise deleted if they have been recognised in a plurality of sensor data captured consecutively in terms of time and/or location.

In a further step S4, a distribution parameter which indicates a spatial distribution of the consistent environmental features 5 in the respective sensor data is determined by an evaluation unit 7. This step can also be carried out in step S3. The number of stored consistent environmental features is then compared with a predetermined first threshold value and the value of the distribution parameter is compared with a predetermined second threshold value by the evaluation unit 7 to determine whether the value is exceeded.

If it is determined in step S4 that the number of stored consistent environmental features and the value of the distribution parameter exceed the assigned threshold value in each case, step S5 is carried out. On the other hand, if it is determined in step S4 that one of the threshold values is not exceeded, there is a return to step S3 and new or further environmental features 5 of the vehicle environment 4 previously passed through are recognised by the recognition unit 6 in new transformed sensor data of the first sensor 2 and the new sensor data captured by the second sensor 3.

According to step S5 (corresponding to step d), the at least one first sensor 2 and the at least one second sensor 3 based on a matching spatial orientation of the recognised consistent environmental features 5 in the transformed sensor data of the first sensor 2 and the sensor data captured by the second sensor 3 are calibrated by the calibration unit 5 by determining extrinsic sensor parameters. The extrinsic sensor parameter is applied to the transformed sensor data of the first sensor and the sensor data captured by the second sensor 3, obtaining calibrated sensor data in each case.

In a subsequent step S6, the intrinsic sensor parameters, the extrinsic sensor parameters, the distortion parameters, the consistent environmental features and/or the distribution parameters are stored on a memory unit 10.

The method 100 ends automatically when the vehicle 1 is taken out of operation or parked, or when a user stops or ends the method 100 manually by means of the operating device 13.

FIG. 4 shows a display device 12 with an operating device 13 according to a preferred embodiment.

The operating device 13 comprises operating elements 16 in order to start, stop or restart the method, wherein further operating elements are conceivable. The operating elements 16 can be designed as touchscreen elements of the display device 12 or as mechanically actuatable buttons.

The transformed sensor data of the at least one first sensor 2 in the form of a camera image 17 and the sensor data of the at least one second sensor 3 in the form of a point cloud 18 are displayed superimposed on one another on the display device 12. Recognised (consistent) environmental features 5 are highlighted by markings 20 (shown here as hatched circles by way of example). In this way, a user can follow the progress of the method in real time and can easily recognise the recognised environmental features without having to be specially trained to do so.

Furthermore, the number of consistent environmental features relative to the first threshold value and the value of the distribution parameter relative to the second threshold value can each be represented as a percentage (illustrated by “XX%”) by a calibration progress indicator 19 with an associated progress bar arranged above it. This further simplifies recognition of the sequence of the method and the progress thereof.

All features disclosed in the application documents are claimed as substantial to the invention, provided that they are, individually or in combination, novel over the prior art.

### LIST OF REFERENCE SIGNS

1 vehicle
100 method
1000 system
2 first sensor
3 second sensor
4 vehicle environment
5 environmental feature
6 calibration unit
7 recognition unit
8 third sensor
9 evaluation unit
10 memory unit
11 computing unit
12 display device
13 operating device
14, 15 signalling connection
16 operating element
15 camera image
16 point cloud
17 calibration progress indicator
20 marking
R movement direction, travel direction
S step

1. Method for automated calibration of sensors in a vehicle comprising the steps of:
a. capturing sensor data elating to a vehicle environment passed through by the vehicle during operation by at least one first passive optical sensor arranged on the vehicle and at least one second active optical sensor arranged on the vehicle;)
b. calibrating the at least one first sensor by determining intrinsic sensor parameters and distortion parameters based on the sensor data captured by the first sensor by a calibration unit and applying the intrinsic sensor parameters and the distortion parameters to the sensor data captured by the first sensor to obtain transformed sensor data;
c. recognising environmental features of the vehicle environment previously passed through in the transformed sensor data of the first sensor and the sensor data captured by the second sensor by a recognition unit; and
d. calibrating the at least one first sensor and the at least one second sensor based on a matching spatial orientation of the recognised environmental features in the transformed sensor data of the first sensor and the sensor data captured by the second sensor by the calibration unit, while determining extrinsic sensor parameters and applying the extrinsic sensor parameters to transformed sensor data from the first sensor and sensor data captured by the second sensor to obtain calibrated sensor data in each case.

2. Method according to claim 1,
wherein:
the environmental features are at least parts of substantially static objects which are arranged in the vehicle environment passed through by the vehicle during operation and were detected by the at least one first sensor and the at least one second sensor using the sensor data, wherein the environmental features are recognised by the recognition unit by means of a gradient-based or a keypoint-based method.

3. Method according to claim1,
wherein
the at least one first sensor designed as a monocular camera or as a stereo camera and the at least one second sensor uses radar, lidar or ultrasound technology or is designed as a time-of-flight camera.

4. Method according to claim 1,
wherein:
the steps a. to c. are continuously repeated, wherein environmental features recognised in step c., if they are recognised as matching in a plurality of sensor data captured consecutively in terms of time and/or location, are stored by the recognition unit as consistent environmental features or are otherwise deleted, wherein step d. is carried out only when the number of consistent environmental features exceeds a predetermined first threshold value.

5. Method according to claim 4,
wherein:
a distribution parameter is determined by an evaluation unit which specifies a spatial distribution of the consistent environmental features in the respective sensor data, wherein step d. is carried out only when the number of consistent environmental features exceeds the first threshold value and when the value of the distribution parameter exceeds a predetermined second threshold value.

6. Method according to claim 1,
wherein:
a third sensor is provided on the vehicle, wherein the third sensor is provided and designed to capture the spatial orientation and movement of the vehicle, wherein the captured spatial orientation and movement of the vehicle are also used for the calibration of the at least one first sensor in step b., wherein the third sensor is a GNSS receiver.

7. Method according to claim 1,
wherein:
the calibration unit, the recognition unit and/or the evaluation unit are arranged on the vehicle or external to the vehicle, wherein the calibration unit, the recognition unit and/or the evaluation unit are designed externally to the vehicle as part of a data processing system or are cloud-based, wherein the intrinsic sensor parameters, the extrinsic sensor parameters, the distortion parameters, the consistent environmental features and/or the distribution parameter are stored in a retrievable manner on a memory unit arranged on the vehicle or external to the vehicle.

8. Method according to claim 1,
wherein:
a sequence of the method is displayed on a display device based on the number of consistent environmental features relative to the first threshold value and the value of the distribution parameter relative to the second threshold value, so that the sequence of the method be followed by a user, wherein an operating device is provided, by means of which the sequence of the method can be regulated by the user.

9. System for carrying out a method according to claim 1, comprising at least one first sensor and at least one second sensor, a calibration unit and a recognition unit.

10. Vehicle equipped with a system according to claim 9.
